(19) United States
(12) Patent Application Publication
(10) Pub. No.: US 2010/0190490 A1
(43) Pub. Date: Jul. 29, 2010

(54) System and Method for Rapid Deployment of a Mobile Device

(76) Inventors: Venugopal KARANCHETI, Bangalore (IN); Avinash Sanka, Khammam (IN); Praveen Raveendraprasad, Karntaka (IN); Priyanka Prabhakar, Bangalore (IN)

Correspondence Address: MOTOROLA, INC., 1303 EAST ALGONQUIN ROAD, IL01/3RD, SCHAUMBURG, IL, 60196, US

(21) Appl. No.: 12/361,942

(22) Filed: Jan. 29, 2009

(51) Int. Cl. H04W 92/00; H04B 7/00

(52) U.S. Cl. 455/426.1; 455/68

(57) ABSTRACT

A system and method rapidly deploys of a mobile device. The system comprises a receiving element and a generation element. The receiving element receives configuration data for a wireless device to be deployed in a network. The generation element generates the configuration data. The generation element prepares the configuration data as a function of a type of the receiving element. The generation element receives data related to the wireless device indicating the type of the receiving element. The data related to the wireless device further indicates select updates to be included in a bundle specified for the wireless device.

### FIELD OF THE INVENTION

The present invention relates generally to a system and method for deploying a mobile device with a network. Specifically, the mobile device receives a package to format the mobile device appropriately prior to associating the mobile device to the network.

### BACKGROUND

When a mobile unit (MU) is added to a network, it must first be configured with parameters compatible with the network. The configuration process may include inputting network identifications and various passwords and/or security codes. An MU new to the network may also lack the latest updates and programs, requiring their download and installation before the MU is fully functional on the network. Even with updated models of the MU, the format of the MU may be outdated when the MU is pulled out of its box.

Currently, a user of the MU manually enters all the necessary configuration information and downloads and installs all the required files. Whether this process is outsourced or executed internally, it is an additional task and cost that delays deployment of the MU. Businesses that employ enterprise mobility solutions today typically have several thousand MUs connected to their network at one time. As the size of these networks grow, the costs and time associated with device roll-out increases exponentially. Moreover, a business with multiple facilities or networks may require that an MU be frequently transported between and reconfigured with different networks.

### SUMMARY OF THE INVENTION

The present invention relates to a system and method for a rapid deployment of a mobile device. The system comprises a receiving element and a generation element. The receiving element receives configuration data for a wireless device to be deployed in a network. The generation element generates the configuration data. The generation element prepares the configuration data as a function of a type of the receiving element. The generation element receives data related to the wireless device indicating the type of the receiving element. The data related to the wireless device further indicates select updates to be included in a bundle specified for the wireless device.

### DESCRIPTION OF THE DRAWINGS

FIG. 1 shows an exemplary embodiment of a mobile network employing a rapid deployment system according to the present invention.

FIG. 2 shows an exemplary embodiment of a first graphical user interface for creating a staging profile for a mobile unit according to the present invention.

FIG. 3 shows an exemplary embodiment of a second graphical user interface to identify staging settings and a relay server for a mobile unit according to the present invention.

FIG. 4 shows an exemplary embodiment of a third graphical user interface to specify a bundle for a mobile unit according to the present invention.

FIG. 5 shows a first method for rapidly deploying a mobile unit according to an exemplary embodiment of the present invention.

FIG. 6 shows a second method for rapidly deploying a mobile unit according to an exemplary embodiment of the present invention.

FIG. 7 shows a third method for rapidly deploying a mobile unit according to an exemplary embodiment of the present invention.

FIG. 8 shows a fourth method for rapidly deploying a mobile unit according to an exemplary embodiment of the present invention.

FIG. 9 shows a method for selecting among one of the first method of FIG. 5, the second method of FIG. 6, the third method of FIG. 7, and the fourth method of FIG. 8 for rapidly deploying a mobile unit according to an exemplary embodiment of the present invention.

### DETAILED DESCRIPTION

The exemplary embodiments of the present invention may be further understood with reference to the following description and the appended drawings, wherein like elements are referred to with the same reference numerals. Before a new MU may operate in a network environment, it must undergo an initial staging process that may include numerous steps. First, general network configuration information (e.g., IP address, subnet mask, etc.) must be entered in order for the MU to communicate with other devices on the network. Because MUs are usually wireless devices, wireless network information (e.g., ESSI, security encryption keys, etc.) may also be necessary.

Additionally, businesses routinely update their systems with new software, firmware, and programs. Incorrect versions may prevent performance of business functions or produce inaccurate results. By the time a new MU is pulled out of its box, the software components originally installed at the factory may already be outdated. MUs already connected to the network may need to periodically uninstall unused programs and/or download and install updates, a process of supplying services known as provisioning. Other data that may be delivered to the MU includes software licensing information or Dynamically Linked Libraries (DLLs) that link to existing applications for extensibility. A problem currently faced by many network administrators is ensuring uniformity across potentially thousands of mobile devices.

The exemplary embodiments of the present invention described herein include a system and method for rapidly deploying mobile units onto a wireless network. Throughout this description, the exemplary embodiments will be referred to as a rapid deployment (RD) system and the various features and functions may be referred to as RD features and functions. The RD system may alleviate the need for the time consuming and expensive manual configuration and provisioning of MUs being added to a network. After receiving a package of data including configuration commands, the MUs may be quickly and automatically configured to communicate with and receive packets from other network devices. The packages may also include updates, programs and/or other executables. MUs may be configured for the first time or may be reconfigured with new data for operation in the same or a different network.

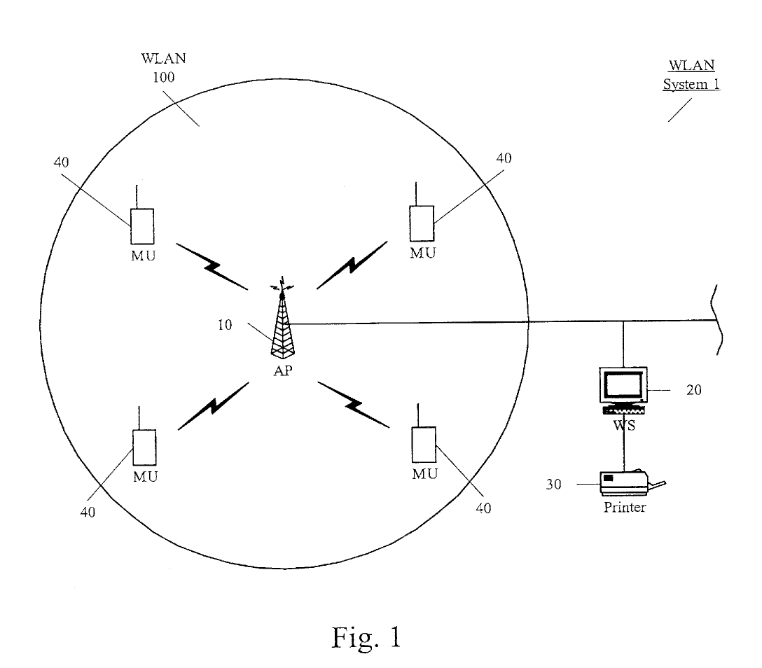

FIG. 1 shows an exemplary mobile network 1 which may employ an exemplary embodiment of the RD system. The mobile network 1 may operate within a Wireless Local Area Network (WLAN) in infrastructure mode. The mobile network 1 may include an access point (AP) 10, a work station (WS) 20, a printer 30, and a plurality of MUs 40. Those skilled in the art will understand that the exemplary embodiments of the present invention may be used with any wireless network and the network 1 is only exemplary.

The WLAN may use a version of the IEEE 802.11 or a similar protocol. One benefit of using a version of the IEEE 802.11 standard is that existing infrastructures using that standard may be adapted to support the RD system with minimal modifications. With only a simple software upgrade, most MUs supporting that standard may operate according to the present invention. In other exemplary embodiments, a different wireless protocol such as Bluetooth may be used.

The AP 10 may be, for example, a router, switch, or bridge that connects the wireless and wired networks. The WS 20 may also be connected to the wired portion of the network and may be located remotely from the AP 10. The WS 20 may be, for example, a desktop or a laptop computer. The printer 30 may be connected directly to the WS 20 or may be a network printer.

The MUs 40 may be any type of computer or processor based portable device equipped with data receiving component (e.g., barcode reader, camera, optical character recognition (OCR), etc.). According to the exemplary embodiments of the present invention, the data receiving component may be related to a transceiver configured to receive a package from a network, an Infrared (IR) reader, a radio frequency identification (RFID) reader, and/or a multimedia messaging service (MMS) component. Since the MUs 40 are portable, they may be capable of connecting to a wireless network and may be sufficiently small to be easily carried. The MUs 40 may be specifically designed to be used only as one of the respective types listed above or may be handheld devices with different purposes. For example, one of the MUs 40 may be a multi-purpose personal digital assistant (PDA) such as those running the Microsoft Pocket PC 2003 operating system or similar and also include the IR reader.

It should be noted that the mobile network 1 employing the RD system is only exemplary. Those skilled in the art will understand that different types of MUs may be used to communicate over the same data network as long as they work under compatible protocols. For example, other configurations with different numbers of MUs, APs, or WSs may also be used to implement the method according to the exemplary embodiments of the present invention.

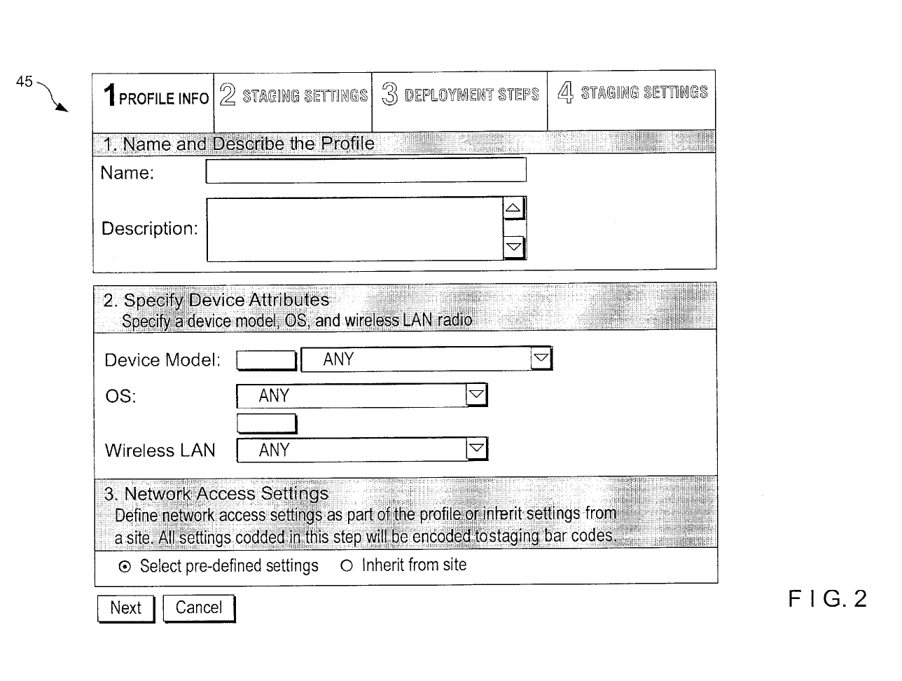

FIG. 2 shows an exemplary embodiment of a GUI 45 used for creating staging profiles on WS 20. As discussed above, staging is a process of quickly preparing MUs into an enterprise by providing settings and/or programs to allow connectivity to the network, thereby enabling communications to devices associated with the network. The staging profile may be a generic term used to describe a content deployment that may be performed as requested by an MU. The staging profile may include staging settings and deployment settings.

The staging settings may define a general network configuration such as an Internet protocol (IP) address and a subnet mask. The general network configuration may provide information for the MU to enable communications with other devices of the network. Because the MUs may be wireless devices, wireless network data such as an Extended Service Set Identifier (ESSI) and security encryption keys may also be provided in the staging settings. The deployment settings may provide new software, new firmware, new programs, etc. that are required to be installed on the MU. The GUI 45 may be used to provide relevant data relating to the MU for the staging profile to be created. As illustrated, a field for a user's name, a field for a description for the profile, fields identifying characteristics of the MU, and a selection for the access settings is provided in the GUI 45.

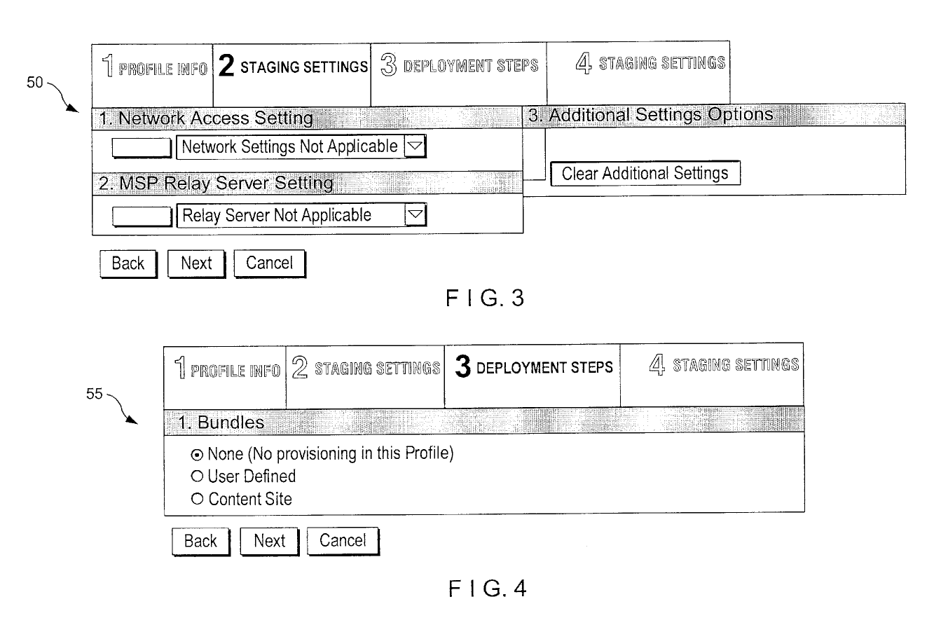

FIG. 3 shows an exemplary embodiment of a GUI 50 used to identify the staging settings and a relay server for the staging profile created from the GUI 45 of FIG. 2. The relay server may be an intermediate server of the RD system used for storing a program(s) and/or software(s) that is to be installed on the MU. That is, the program and/or software may be required to be installed for the MU to communicate with the network. In addition, the GUI 50 may include a field to indicate additional settings for the profile created from the GUI 45. It should be noted that the relay server may be any device on the network that is capable of communicating with the MU. For example, the relay server may be the AP 10, the WS 20, a network management arrangement (NMA), a router, a switch, etc.

FIG. 4 shows an exemplary embodiment of a GUI 55 used to specify a bundle of program(s) and/or software(s) stored on the relay server for the MU attempting to associate with the network. The bundle may further include data specifying program(s) and/or software(s) that require to be uninstalled/removed from the MU. In addition, the bundle may specify an order in which to install/uninstall program(s) and/or software(s) to properly format the MU to a condition fit for association with the network.

The GUIs 45, 50, 55 may be run on the WS 20. The GUIs 45, 50, 55 may also be part of a single sequence performed in a predetermined order (e.g., GUI 45, then GUI 50, then GUI 55). The WS 20 may be configured with any RD program capable of creating, editing, and displaying staging profiles. Upon receiving the parameters of the GUIs 45, 50, 55, the RD program of the WS 20 may determine the bundle in which the MU requires to be installed/uninstalled. The WS 20 may also store various programs and/or softwares that a potential MU may require. Thus, the RD program may determine the contents of the bundle as well as preparing the bundle for transmission to the MU.

The bundle may be delivered to the MU in a variety of methods. As will be discussed below, the bundle may be available for the MU to install the components therein via the relay server. The WS 20 may forward or instruct the relay server of the bundle with which the MU is required to install/uninstall. The MU may also receive the staging settings so that the MU will initially be capable of connecting to the network and subsequently be capable of installing/uninstalling according to the bundle forwarded to the relay server. In a first exemplary embodiment, a Multimedia Messaging Service (MMS) may be used to transmit the staging settings from the WS 20 to the MU 40. In a second exemplary embodiment, a Bluetooth connection may be used to transmit the staging settings from the WS 20 to the MU 40. In a third exemplary embodiment, an infrared (IR) receiver may receive the staging settings from the WS 20. In a fourth exemplary embodiment, a radio frequency identification (RFID) tag may be used to receive the bundle from the WS 20.

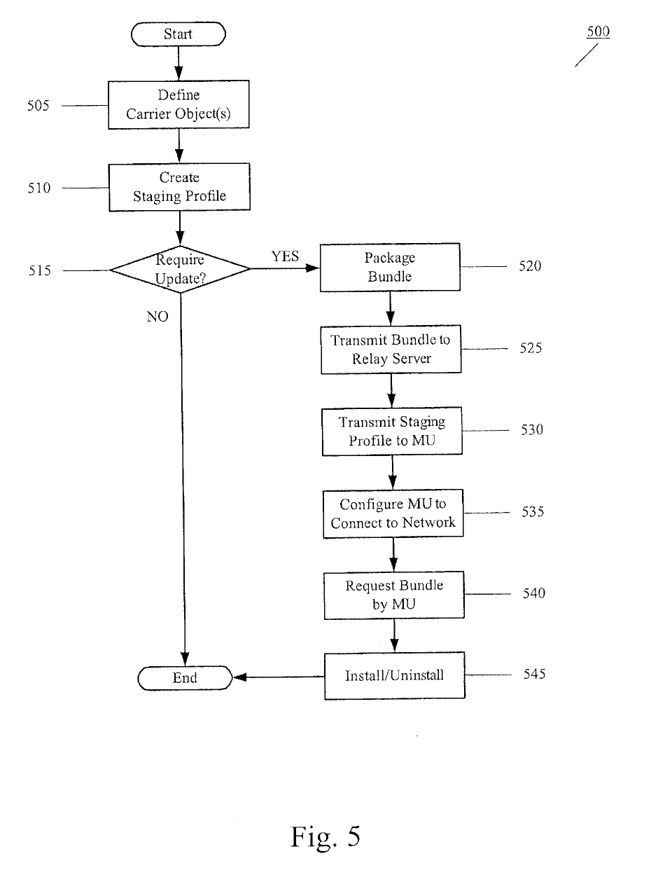

FIG. 5 shows a first method 500 for rapidly deploying an MU according to an exemplary embodiment of the present invention. The first method 500 may be when the staging settings from the WS 20 is transmitted to the MU 40 using a MMS. The first method 500 will be described with reference to the RD system 1 of FIG. 1 and the GUIs 45, 50, 55 of FIGS. 2-4, respectively.

In step 505, a short messaging service (SMS) carrier object is identified for the MU that is to be rapidly deployed. In conventional technologies, SMS has provided the use of a text messaging functionality for MUs. According to the exemplary embodiments of the present invention of the first method 500, the SMS carrier object may be used to define a network provider in which the MU utilizes for services and MMS message delivery. By identifying the SMS carrier object, the WS 20 may be capable of transmitting data to the MU 40. The SMS carrier object may be a default setting of the MU 40 associated with a particular network provider. Accordingly, if the WS 20 is aware of the SMS carrier object, a protocol used by the network provider may also be used by the WS 20 to transmit data to the MU 40.

In step 510, the staging profile is created. As discussed above, the staging profile may be created using the GUIs 45, 50, 55. As discussed above, the GUI 45 may indicate a user name and a brief description as well as device attributes and network access settings. The GUI 50 may identify the staging settings such as the network access settings and the relay server. The GUI 55 may specify the bundle for the MU to be rapidly deployed.

In step 515, a determination may be made whether the MU requires an update. As discussed above, a new MU out of the box may require programs and/or softwares to be updated to properly associate with a network. However, there is also the scenario where the MU does not require an update and default settings may enable a proper association with the network. The determination may be made in the prior step 510 where the staging profile is created. The WS 20 may include a database that identifies the MU specifically based on the entries in the GUIs 45, 50, 55. The database may further indicate the bundle for the MU. As discussed above, the database may be part of the relay server. If the MU does not require the update, the method 500 ends.

If step 515 determines that the MU requires an update, the method 500 continues to step 520. In step 520, the bundle is prepared for transmission to the relay server. As discussed above, the relay server may be used as an intermediary that stores the updated programs and softwares for the MUs. Furthermore, the relay server may be a separate unit of the RD system or may be part of one of the components of the RD system as described above. In a first exemplary embodiment, the WS 20 may indicate selected programs and/or softwares to the relay server that the MU is required to install for deployment. In a second exemplary embodiment, the WS 20 may forward a message to the relay server. The relay server may then prepare the bundle by retrieving the selected programs and/or softwares within its own database and subsequently packaging the bundle. In addition, the bundle may indicate to the MU any programs and/or softwares that are to be uninstalled. The bundle may be encoded for the specific use by the MU. The encoding of the bundle may also be used to decrease an overall size of the bundle. For example, the MU to be rapidly deployed may require a large number of programs and/or softwares. By encoding the bundle to be compressed, a time necessary for the bundle to be received by the MU is decreased.

In step 525, the bundle is transmitted from the WS 20 to the relay server in preparation for the install/uninstall to be performed by the MU. In step 530, the staging profile is transmitted from the WS 20 to the MU. The transmitting of the staging profile to the MU and the transmitting of the bundle to the relay server may be performed interchangeably or concurrently. In a first example, the bundle may be transmitted prior to transmitting the staging profile so that when the MU is capable of connecting to the network, the bundle may be readily available. In a second example, the staging profile may be transmitted prior to transmitting the bundle because the configuring of the MU may require time.

It should be noted that steps 505-530 may be performed on the side of the WS 20. That is, the WS 20 and related devices such as the relay server, a database connected thereto, etc. may perform the steps 505-530. However, as discussed above, the use of the WS 20 is only exemplary. Other network devices configured to perform the steps 505-525 may also be used. For example, a switch, a router, an access point, a network management arrangement, etc. may also be used. Furthermore, as will be discussed below, upon the staging profile being transmitted, the steps 535-545 may be related to the MU. That is, the MU that is to be rapidly deployed may perform the steps 530-545.

In step 535, the MU is configured to connect to the network according to the specifications indicated in the staging profile. As discussed above, the staging profile may include data relating uniquely to the MU and the variety of parameters of the MU. Through the settings indicated in the MU, a proper configuration may be performed so that the MU may successfully connect to the network.

In step 540, the MU requests the bundle for the rapid deployment thereof. At this point, the MU may be capable of connecting to the network (step 535). Subsequently, the MU may request the bundle from the appropriate network device. According to the exemplary embodiments of the present invention, the MU may be directed to the relay server which stores the bundle that was transmitted from the WS 20. The bundle stored in the relay server may be encoded for the MU. The bundle may include the programs and/or the softwares that the MU is to install as well as an indication or command for the programs and/or the softwares to be uninstalled. Each program and/or software may be formatted into an appropriate style to be installed onto the MU. The uninstall portion of the bundle may also be decoded to extract an executable that uninstalls the indicated parts notated therein. Thus, in step 545, the programs and/or the softwares of the bundle are installed/uninstalled.

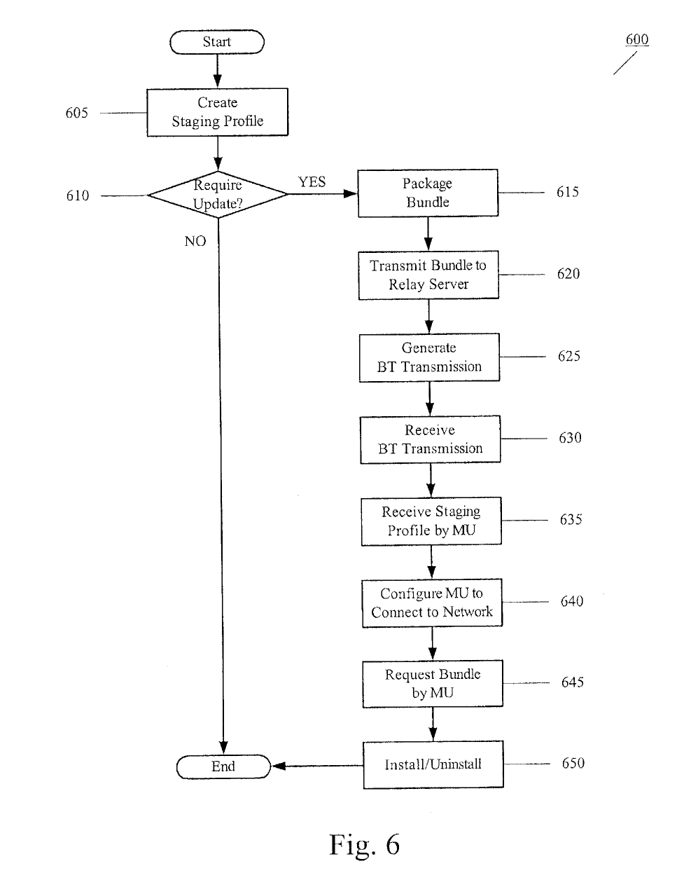

FIG. 6 shows a second method 600 for rapidly deploying an MU according to an exemplary embodiment of the present invention. The second method 600 may be when the staging profile from the WS 20 is transmitted to the MU 40 using Bluetooth. The second method 600 will be described with reference to the RD system 1 of FIG. 1 and the GUIs 45, 50, 55 of FIGS. 2-4, respectively.

In step 605, the staging profile is created. Step 605 may be substantially similar to step 510 of the method 500 of FIG. 5. Thus, the staging profile may be created using the GUIs 45, 50, 55. The GUI 45 may indicate a user name and a brief description as well as device attributes and network access settings. The GUI 50 may identify the staging settings such as the network access settings and the relay server. The GUI 55 may specify the bundle for the MU to be rapidly deployed.

In step 610, a determination may be made whether the MU requires an update. Step 610 may be substantially similar to step 515 of the method 500 of FIG. 5. If the MU does not require the update, the method 600 ends. If step 610 determines that the MU requires an update, the method 600 continues to step 615.

In step 615, the bundle is prepared for transmission to the relay server. The bundle may be prepared in a variety of manners such as those discussed above with reference to the method 500 of FIG. 5. In step 620, the bundle is transmitted from the WS 20 to the relay server.

In step 625, the Bluetooth transmission is generated. The Bluetooth transmission may include the staging profile to be received by the MU. It should be noted that the generation of the Bluetooth transmission and the transmitting of the bundle to the relay server may be performed interchangeably or concurrently. In a first example, the bundle may be transmitted prior to generating the Bluetooth transmission so that when the MU is capable of connecting to the network, the bundle may be readily available. In a second example, the Bluetooth transmission may be generated prior to transmitting the bundle because the configuring of the MU may require time.

It should be noted that steps 605-625 may be performed on the side of the WS 20. That is, the WS 20 and related devices such as the relay server, a database connected thereto, etc. may perform the steps 605-625. However, as discussed above, the use of the WS 20 is only exemplary. Other network devices configured to perform the steps 605-625 may also be used. For example, a switch, a router, an access point, a network management arrangement, etc. may also be used. Furthermore, as will be discussed below, upon the RFID tag being generated, the steps 630-650 may be related to the MU. That is, the MU that is to be rapidly deployed may perform the steps 630-650.

In step 630, the MU receives the Bluetooth transmission. In step 635, the MU decodes the staging profile to configure the MU to be capable of connecting to the network. Thus, in step 640, the MU is configured to connect to the network according to the specifications included in the staging profile. Once the MU is capable of connecting to the network, in step 645, the MU requests the bundle in a substantially similar manner as discussed above with reference to step 540 of the method 500 of FIG. 5. Subsequently, in step 650, the MU installs/uninstalls the bundle.

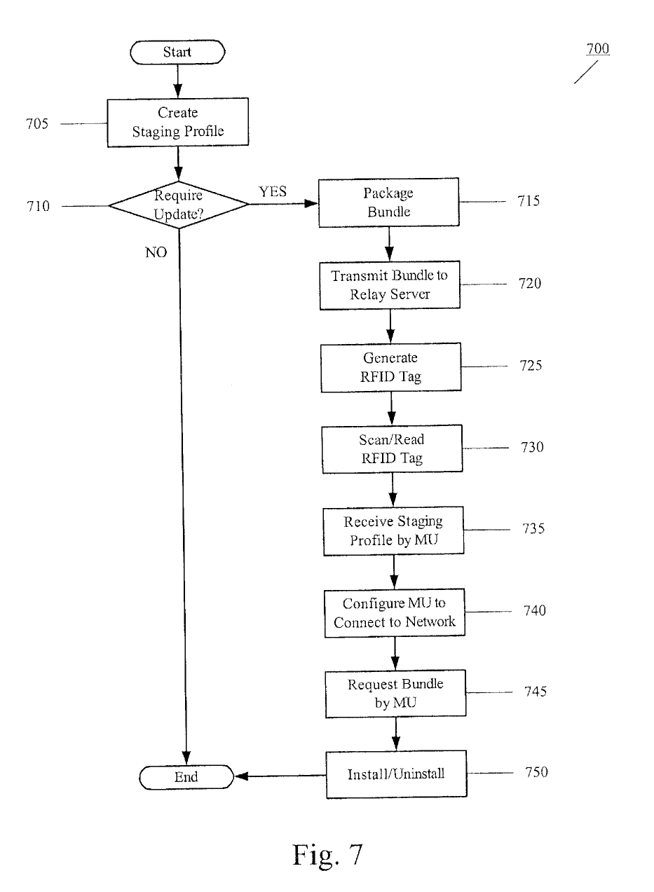

FIG. 7 shows a third method 700 for rapidly deploying an MU according to an exemplary embodiment of the present invention. The third method 700 may be when the staging profile from the WS 20 is transmitted to the MU 40 using RFID. The third method 700 will be described with reference to the RD system 1 of FIG. 1 and the GUIs 45, 50, 55 of FIGS. 2-4, respectively.

As discussed above, the MU 40 may be equipped with an RFID reader. Accordingly, an RFID tag may be generated. The RFID tag may be a reconfigurable tag. For example, the RFID tag may be an attachment for the AP having an operating area in which the MU 40 is disposed therein. The RFID tag may generate a beacon that is transmitted within the operating area so that the RFID reader of the MU 40 is capable of receiving the beacon. In another example, the RFID tag may be an attachment for the WS 20. The MU 40 may be within a distance of the RFID tag to read or scan the RFID tag. In a further example, the RFID tag may be brought to the MU 40 to enable the RFID reader to read or scan the RFID tag. Thus, the RFID tag may be a singular unit reconfigured for each instance of a rapid deployment of an MU. The RFID tag may also be an attachment for various network devices. As discussed above, the RFID tag may be an attachment for an AP, the WS 20, or a portable unit. In other exemplary embodiments, the RFID tag may be an attachment for other devices such as the relay server.

In step 705, the staging profile is created. Step 705 may be substantially similar to step 510 of the method 500 of FIG. 5. Thus, the staging profile may be created using the GUIs 45, 50, 55. The GUI 45 may indicate a user name and a brief description as well as device attributes and network access settings. The GUI 50 may identify the staging settings such as the network access settings and the relay server. The GUI 55 may specify the bundle for the MU to be rapidly deployed.

In step 710, a determination may be made whether the MU requires an update. Step 710 may be substantially similar to step 515 of the method 500 of FIG. 5. If the MU does not require the update, the method 700 ends. If step 710 determines that the MU requires an update, the method 700 continues to step 715.

In step 715, the bundle is prepared for transmission to the relay server. The bundle may be prepared in a variety of manners such as those discussed above with reference to the method 500 of FIG. 5. In step 720, the bundle is transmitted from the WS 20 to the relay server.

In step 725, the RFID tag is generated. The RFID tag may include the staging profile to be received by the MU. Those skilled in the art will understand that the RFID tag may be, for example, a passive tag, an active tag, or a semi-passive tag. It should be noted that the generation of the RFID tag and the transmitting of the bundle to the relay server may be performed interchangeably or concurrently. In a first example, the bundle may be transmitted prior to generating the RFID tag so that when the MU is capable of connecting to the network, the bundle may be readily available. In a second example, the RFID tag may be generated prior to transmitting the bundle because the configuring of the MU may require time.

It should be noted that steps 705-725 may be performed on the side of the WS 20. That is, the WS 20 and related devices such as the relay server, a database connected thereto, etc. may perform the steps 705-725. However, as discussed above, the use of the WS 20 is only exemplary. Other network devices configured to perform the steps 705-725 may also be used. For example, a switch, a router, an access point, a network management arrangement, etc. may also be used. Furthermore, as will be discussed below, upon the RFID tag being generated, the steps 730-750 may be related to the MU. That is, the MU that is to be rapidly deployed may perform the steps 730-750.

In step 730, the MU scans or reads the RFID tag. As discussed above, the RFID tag may be disposed in a variety of locations. In a first example, when the RFID tag is an attachment of the AP, the MU 40 may be in a location covered by an operating area of the AP. Thus, the MU 40 may be capable of receiving a beacon transmitted by the RFID tag. In a second example, when the RFID tag is an attachment of the WS 20, the MU 40 may be moved to a location near the WS 20 to scan or read the RFID tag. In a third example, when the RFID tag is portable, the RFID tag may be moved to a location near the MU 40 to scan or read the RFID tag.

In step 735, the MU receives the staging profile to configure the MU to be capable of connecting to the network.

Thus, in step 740, the MU is configured to connect to the network according to the specifications included in the staging profile. Once the MU is capable of connecting to the network, in step 745, the MU requests the bundle in a substantially similar manner as discussed above with reference to step 540 of the method 500 of FIG. 5. Subsequently, in step 750, the MU installs/uninstalls the bundle.

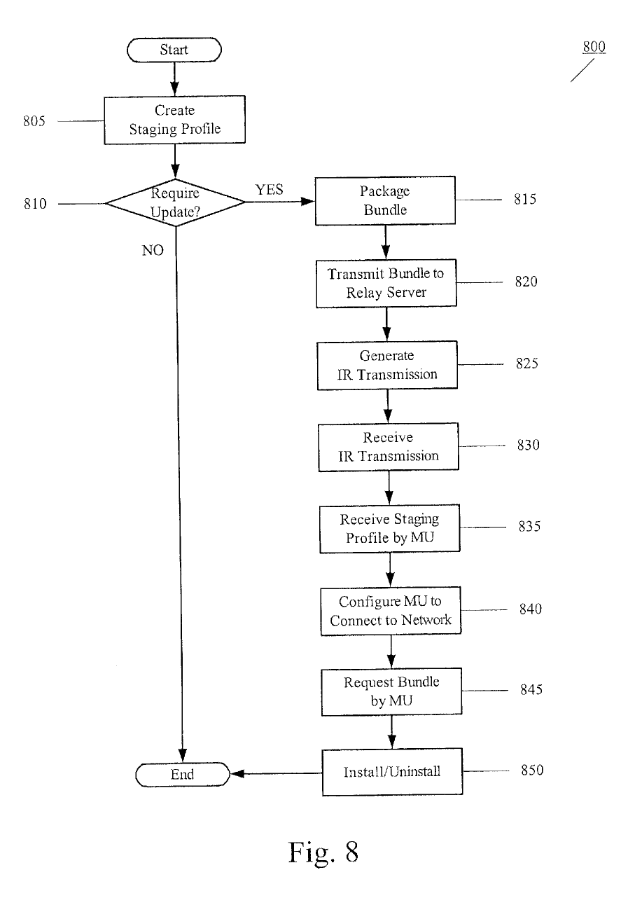

FIG. 8 shows a fourth method 800 for rapidly deploying an MU according to an exemplary embodiment of the present invention. The fourth method 800 may be when the staging profile from the WS 20 is transmitted to the MU 40 using IR. The fourth method 800 will be described with reference to the RD system 1 of FIG. 1 and the GUIs 45, 50, 55 of FIGS. 2-4, respectively.

As discussed above, the MU 40 may be equipped with an IR reader. Accordingly, a network device may include an IR transmitter. The network device may be, for example, the WS 20, the AP 10, the relay server, etc. In contrast to the RFID tag, the IR transmitter may rely on a shorter distance for the IR transmission. Thus, the MU 40 may be required to be within a predetermined proximity of the respective network device with the IR transmitter. The IR transmitter may be an attachment that couples to the network device.

In step 805, the staging profile is created. Step 805 may be substantially similar to step 510 of the method 500 of FIG. 5. Thus, the staging profile may be created using the GUIs 45, 50, 55. The GUI 45 may indicate a user name and a brief description as well as device attributes and network access settings. The GUI 50 may identify the staging settings such as the network access settings and the relay server. The GUI 55 may specify the bundle for the MU to be rapidly deployed.

In step 810, a determination may be made whether the MU requires an update. Step 810 may be substantially similar to step 515 of the method 500 of FIG. 5. If the MU does not require the update, the method 700 ends. If step 810 determines that the MU requires an update, the method 800 continues to step 815.

In step 815, the bundle is prepared for transmission to the relay server. The bundle may be prepared in a variety of manners such as those discussed above with reference to the method 500 of FIG. 5. In step 820, the bundle is transmitted from the WS 20 to the relay server.

In step 825, the IR transmission is generated. The IR transmission may include the staging profile to be received by the MU. It should be noted that the generation of the IR transmission and the transmitting of the bundle to the relay server may be performed interchangeably or concurrently. In a first example, the bundle may be transmitted prior to generating the IR transmission so that when the MU is capable of connecting to the network, the bundle may be readily available. In a second example, the IR transmission may be generated prior to transmitting the bundle because the configuring of the MU may require time.

It should be noted that steps 805-825 may be performed on the side of the WS 20. That is, the WS 20 and related devices such as the relay server, a database connected thereto, etc. may perform the steps 805-825. However, as discussed above, the use of the WS 20 is only exemplary. Other network devices configured to perform the steps 805-825 may also be used. For example, a switch, a router, an access point, a network management arrangement, etc. may also be used. Furthermore, as will be discussed below, upon the RFID tag being generated, the steps 830-850 may be related to the MU. That is, the MU that is to be rapidly deployed may perform the steps 830-850.

In step 830, the MU receives the IR transmission. As discussed above, the IR transmitter may be disposed in a variety of locations. The IR receiver may be required to be positioned in a predetermined position to receive the IR transmission. The IR transmission from the respective network device may be substantially linear. Thus, the IR receiver may be required to be aligned for the reception.

In step 835, the MU receives the staging profile to configure the MU to be capable of connecting to the network. Thus, in step 840, the MU is configured to connect to the network according to the specifications included in the staging profile. Once the MU is capable of connecting to the network, in step 845, the MU requests the bundle in a substantially similar manner as discussed above with reference to step 540 of the method 500 of FIG. 5. Subsequently, in step 850, the MU installs/uninstalls the bundle.

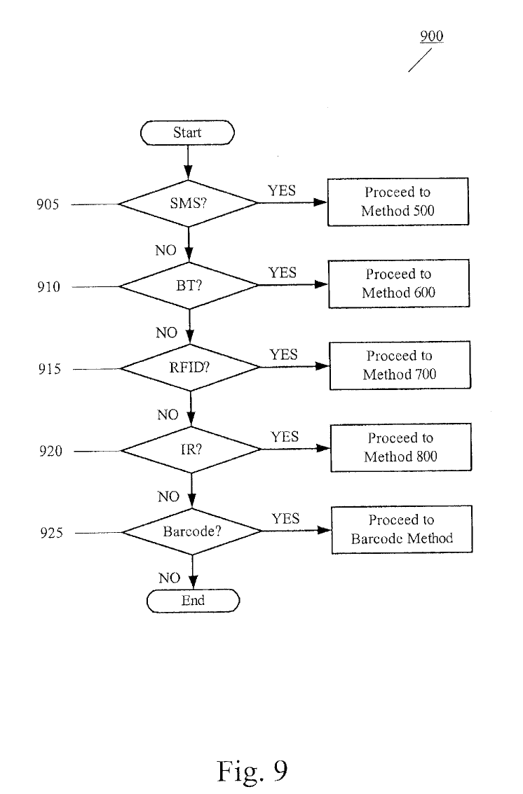

FIG. 9 shows a method 900 for selecting among one of the first method 500 of FIG. 5, the second method 600 of FIG. 6, the third method 700 of FIG. 7, and the fourth method 800 of FIG. 8 for rapidly deploying a mobile unit according to an exemplary embodiment of the present invention. Method 900 incorporates a relative distance in which an MU is required to be disposed with respect to a source that provides the bundle for the rapid deployment. The method 900 considers a furthest distance to provide the most convenience while a closest distance provides the least convenience.

In step 905, a determination is made whether a SMS means is included in the MU. In the exemplary embodiment where the MU includes the SMS means, the MU is merely required to be within an operating area of the respective network device that provides the bundle. Thus, if the MU includes the SMS means, the method 800 proceeds to the method 500 of FIG. 5.

In step 910, a determination is made whether a Bluetooth means is included in the MU. In the exemplary embodiment where the MU includes the Bluetooth means, the MU is required to be within an operating area of the Bluetooth transmitter that provides the staging profile. Thus, if the MU includes the Bluetooth means, the method 900 proceeds to the method 600 of FIG. 6.

In step 915, a determination is made whether an RFID reader is included in the MU. In the exemplary embodiment where the MU includes the RFID reader, the MU is required to be within a beacon transmission area of the RFID tag. Thus, if the MU includes the RFID reader, the method 900 proceeds to the method 700 of FIG. 7. It should be noted that the relative distance that the RFID tag is capable of transmitting depends on the technical components comprised therein. Thus, it is conceivable that the RFID tag is capable of transmitting a further distance than the Bluetooth or SMS means. In such an embodiment, the method 800 may initially consider step 915 prior to step 905 or 910.

In step 920, a determination is made whether an IR receiver is included in the MU. In the exemplary embodiment where the MU includes the IR receiver, the MU is required to be aligned with the IR transmitter and within a transmission range of the IR transmitter. Thus, if the MU includes the IR receiver, the method 900 proceeds to the method 800 of FIG. 8.

In step 925, a determination is made whether a barcode scanner is included in the MU. In the exemplary embodiment where the MU includes the barcode scanner, the MU is required to be within a scanning range of the barcode scanner to properly receive the data encoded in a barcode produced by the WS 20. Thus, if the MU includes the barcode scanner, the method 900 proceeds to the method described in U.S. Pat. No. 7,306,153.

If none of the above means is identified through the course of the method 900, the method 900 may end. However, in other exemplary embodiments, when none of the above means is identified, a manual update of the MU may be performed. For example, portable storage devices such as a CD-ROM, portable hard drive, flash drive, etc. may be used to transport the updates for the MU. The MU may be required to have a port that is capable of receiving the portable storage device.

The exemplary embodiments of the present invention provide a system and method for rapidly deploying an MU with a network. The rapid deployment of the MU enables the MU to communicate with network devices as well as other devices associated with the network. The exemplary embodiments of the present invention also provide various means for the MU to receive a bundle that includes programs and/or softwares to properly configure the MU for the deployment. In a first exemplary embodiment, the MU may include a SMS connectivity device. In a second exemplary embodiment, the MU may include a Bluetooth transceiver. In a third exemplary embodiment, the MU may include an RFID reader. In a fourth exemplary embodiment, the MU may include an IR receiver. The flexible nature of the component used by the MU to receive the bundle further facilitates the rapid deployment of the MU with the network.

It should be noted that the exemplary embodiments of the present invention may also be used as a system for updating current MUs that are already deployed with the network. For example, the above described means for receiving the bundle by the MU for the initial rapid deployment may also be used as a means for regularly updating the MU to continue to be deployed with the network.

It should also be noted that the programs and/or softwares that are installed or uninstalled is only exemplary. That is, other types of information may also be included in the bundle. For example, the bundles may include licensing information for the device and/or software included on the device. This licensing information may include manners of registering the device when it is connected to the network, accepting use licenses for software, etc.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a receiving element to receive configuration data for a wireless device to be deployed in a network; and
a generation element to generate the configuration data, the generation element preparing the configuration data as a function of a type of the receiving element, the generation element receiving data related to the wireless device indicating the type of the receiving element, the data related to the wireless device further indicating select updates to be included in a bundle specified for the wireless device.

2. The system of claim 1, wherein the receiving element is at least one of a Bluetooth receiver, a multimedia messaging service (MMS) component, a radio frequency identification (RFID) reader, and an Infrared (IR) receiver.

3. The system of claim 2, wherein the generation element is at least one of a Bluetooth transmitter, a MMS transmitter, an RFID tag, and an IR transmitter.

4. The system of claim 1, wherein the updates relate to at least one of programs and softwares that is to be at least one of installed and uninstalled on the wireless device.

5. The system of claim 1, wherein the generation element includes a graphical user interface (GUI) to enter the data related to the wireless device.

6. The system of claim 1, wherein the generation element is part of a device of the network.

7. The system of claim 6, wherein the device of the network includes at least one of a work station, a relay server, an access point, and a portable device.

8. The system of claim 3, wherein, when the receiving element is the MMS component, the generation element determines a short messaging service (SMS) carrier to transmit the configuration data when the receiving element is within an operating area of the generation element.

9. The system of claim 3, wherein, when the receiving element is one of the Bluetooth receiver and the RFID reader, the receiving element is within a transmission range of the generation element.

10. The system of claim 3, wherein, when the receiving element is the IR receiver, the receiving element is aligned with the generation element to receive the bundle.

11. A method, comprising:
receiving, by a generation element, data related to a wireless device including a receiving element, the data related to the wireless device indicating a type of the receiving element and further indicating select updates to be included in a bundle specified for the wireless device;
preparing configuration data for the wireless device to be deployed in a network as a function of a type of the receiving element;
generating the bundle; and
transmitting the bundle to the receiving element to update the wireless device.

12. The method of claim 11, wherein the receiving element is at least one of a Bluetooth receiver, a multimedia messaging service (MMS) component, a radio frequency identification (RFID) reader, and an Infrared (IR) receiver.

13. The method of claim 12, wherein the generation element is at least one of a Bluetooth transmitter, a MMS transmitter, an RFID tag, and an IR transmitter.

14. The method of claim 11, wherein the configuration data relates to at least one of programs and softwares that is to be at least one of installed and uninstalled on the wireless device.

15. The method of claim 11, further comprising:
entering the data related to the wireless device via a GUI of the generation element.

16. The method of claim 11, wherein the generation element is part of a device of the network, the device of the network being at least one of a work station, a relay server, an access point, and a portable device.

17. The method of claim 13, further comprising:
when the receiving element is the MMS component, determining a SMS carrier to transmit the bundle when the receiving element is within an operating area of the generation element.

18. The method of claim 13, wherein, when the receiving element is one of the Bluetooth receiver and the RFID reader, the receiving element is within a transmission range of the generation element.

19. The method of claim 13, further comprising:
when the receiving element is the IR receiver, aligning the receiving element with the generation element to receive the bundle.

20. A system, comprising:
a receiving means for receiving configuration data for a wireless device to be deployed in a network; and
a generation means for generating the configuration data, the generation means preparing the configuration data as a function of a type of the receiving means, the generation means receiving data related to the wireless device indicating the type of the receiving means, the data related to the wireless device further indicating select updates to be included in a bundle specified for the wireless device.
